(19) United States
(12) Patent Application Publication
(10) Pub. No.: US 2006/0250635 A1
(43) Pub. Date: Nov. 9, 2006

(54) Information processing apparatus, information processing method, computer program, and image forming system

(75) Inventors: Michiharu Masuda, Abiko-shi (JP); Tsunao Hombo, Tokyo (JP); Shunichi Komatsu, Abiko-shi (JP); Michio Kawase, Abiko-shi (JP); Yoshihito Osari, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/481,912

(22) Filed: Jul. 7, 2006

Related U.S. Application Data
(63) Continuation of application No. PCT/JP06/30090, filed on Jan. 16, 2006.

(30) Foreign Application Priority Data
Jan. 17, 2005 (JP) 2005-009072

(51) Int. Cl. G06K 15/00

(52) U.S. Cl. 358/1.14; 382/124

(57) ABSTRACT

The invention provides an information processing apparatus in which print data is inputted, whether or not authentication information has been added to the print data is discriminated, and an output destination of the print data is controlled on the basis of the discrimination result, thereby making it possible to prevent the print data from being sent to an image output apparatus of a low security level.

This application is a continuation of International Application No. PCT/JP2006/300900, filed Jan. 16, 2006, which claims the benefit of Japanese Patent Application No. 2005-009072 filed Jan. 17, 2005.

### BACKGROUND OF THE INVENTION

1. Field of the Invention

The invention relates to an information processing apparatus, an information processing method, a computer program, and an image forming system for controlling an output destination on the basis of authentication information.

2. Related Background Art

Hitherto, there is a function called BOX printing in an image output apparatus in order to assure security of a print job. According to such a function, data added with a job ID or a user ID is transmitted from a host to an image output apparatus and the data received by the image output apparatus is stored into a storage medium in the image output apparatus. Upon printing of the data, the job ID which has previously been added to the reception data or the user ID such as a user password or the like of a creator of the image data is inputted and the print data is printed after the authentication of the user ID. By such a function, it is possible to prevent such a situation that an image is outputted to unspecified users and information leaks.

According to Japanese Patent Application Laid-Open No. H11-301058, although the printing can be controlled by the ID authentication, if the ID leaks to the third person or a card is stolen, there is a fear that the print data in the image output apparatus is stolen by the third person. According to the BOX function in a conventional network printer, when a job is inputted, an image output destination can be freely selected irrespective of a security level of the job. Therefore, when the image output apparatus without the BOX function is erroneously selected, the data is transmitted to the selected image output apparatus and there is a fear that the outputted print data is stolen by the third person.

### SUMMARY OF THE INVENTION

It is an object of the invention to provide an information processing apparatus in which an image forming apparatus to which data is to be outputted is restricted on the basis of authentication information added to a job and it is possible to prevent information of a high security level from being transmitted to an image output apparatus of the low security.

To accomplish the above object, according to the invention, there is provided an information processing apparatus comprising: input means adapted to input print data; discriminating means adapted to discriminate whether or not authentication information has been added to the print data; and control means adapted to control an output destination of the print data on the basis of a result of the discrimination by the discriminating means.

According to the invention, a printing apparatus to which the print data is outputted is limited on the basis of the authentication information associated to a job which is inputted. Therefore, it is possible to prevent such a situation that the information of a high security level is transmitted to the image output apparatus of the low security which is used by an unspecified number of users. An image forming system of a higher security level can be provided.

Another object of the invention is to provide a novel function. Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing an outline of an image forming system according to an embodiment;

FIG. 2 is a constructional diagram of a fingerprint reading device in the embodiment;

FIG. 3 is a constructional diagram of a fingerprint reading unit in the embodiment;

FIG. 4 is a constructional diagram of a computer in the embodiment;

FIG. 5 is a flowchart for explaining processes of the computer in the embodiment;

FIG. 6 is a constructional diagram of a printer server in the first embodiment;

FIG. 7 is a flowchart for explaining processes of the printer server in the first embodiment;

FIG. 8 is a constructional diagram of an image forming apparatus in the embodiment;

FIG. 9 is a control block diagram of the image forming apparatus in the embodiment;

FIG. 10 is a constructional diagram of a printer server in the second embodiment;

FIG. 11 is a flowchart for explaining processes of the printer server in the second embodiment;

FIG. 12 is a flowchart for explaining a flow for a printing process in the embodiment; and

FIG. 13 shows tables stored in an ID information discriminating unit in the embodiment.

### DETAILED DESCRIPTION OF THE PREFERRED EMBODIMENTS

### First Embodiment

A preferred embodiment of the invention will be described hereinbelow with reference to the drawings. System configuration

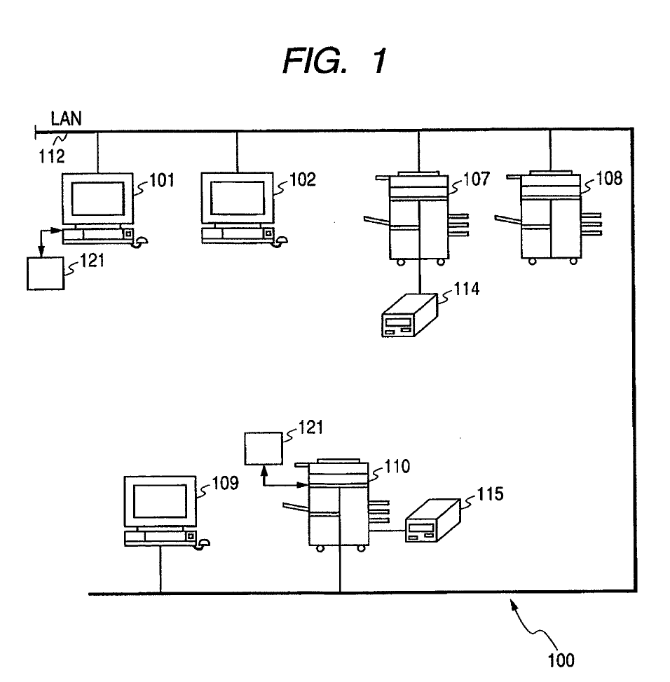

FIG. 1 is a block diagram showing an outline of an image forming system according to the embodiment. As shown in FIG. 1, in an image forming system 700 of the embodiment, computers 101 and 109 serving as a plurality of client machines, image forming apparatuses 107, 108, and 110, and a printer server 102 are connected to an LAN 112. The computers 101 and 109 are personal computers which are ordinarily used by the users. The users operate those computers in order to form documents, execute transmission and reception of E-mail to/from other computers connected onto the network, or the like. The computer 109 has ID registering means adapted to register an ID by a key input through a keyboard, while the computer 101 has an ID information input device 121 in addition to the ID registering means which is operated by the key input. The printer server 102 makes management of a print queue, management of user accounts, and the like. The printer server 102 has a function of discriminating ID information added to print data and, further, a function of discriminating a security level corresponding to the discriminated ID information.

Each of the image forming apparatuses 107, 108, and 110 is a hybrid image forming apparatus having a large liquid crystal touch panel and having both of a scanner function and a printer function. That is, each apparatus has not only a copying function as a sole apparatus but also a function serving as an electronic filing apparatus by connecting magnetooptic disk units 114 and 115 to the apparatus. Each of the image forming apparatuses 107, 108, and 110 also functions as a printer for the computers 101 and 109. Each apparatus receives, through the LAN 112, image forming command data or the like regarding documents formed by the computers 101 and 109 and develops it into bit map image data, thereby printing it. The image forming apparatus 110 has the ID information input device 121 and ID authenticating means based on ID information inputted from the ID information input device 121. The image forming apparatus 108 does not have authenticating means and, therefore, is an apparatus of the lowest security level. Since each image forming apparatus has its own security level, the proper image forming apparatus which can output is specified in accordance with the security level of a print job. That is, in response to the job of the low security level, the print data is printed by the image forming apparatus having the low security level. In response to the job of the high security level, the print data is printed by the image forming apparatus having the high security level.

According to the foregoing image forming system, when the system is activated, each of the image forming apparatuses 107, 108, and 110 notifies the printer server 102 of the security level of each image forming apparatus, so that the printer server 102 grasps the security level of each image forming apparatus.

In the embodiment, to provide the image forming system of the higher security level, fingerprint authentication is made by using a fingerprint reading device as an ID information input device 121. As an authenticating method, it is possible to use password authentication using ID information according to a combination of numerals or biometrics authentication for making authentication by using a part of a human body.

Description of the Apparatus Construction

<Image Forming Apparatus>

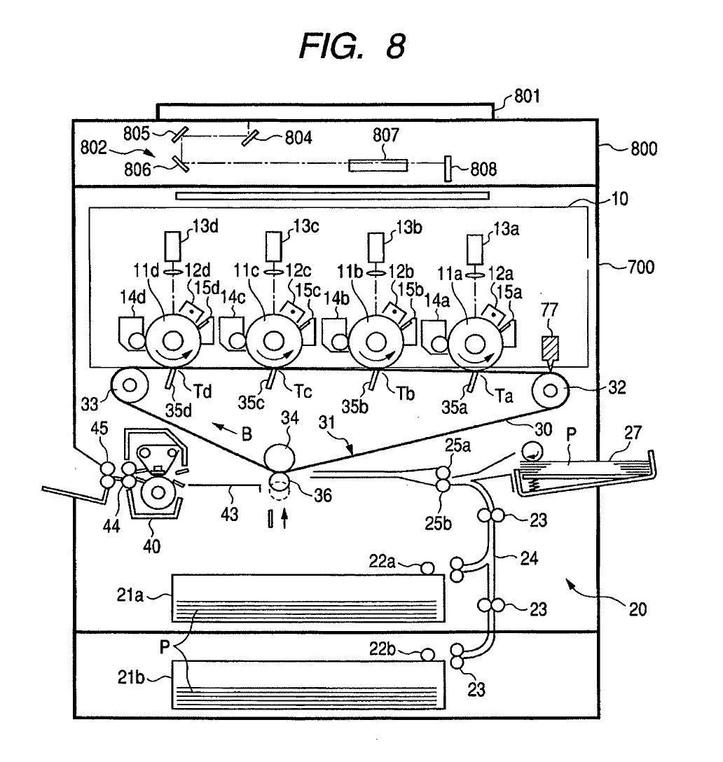

FIG. 8 is a constructional diagram of each of the image forming apparatuses 107, 108, and 110. Although a scanner unit 800 and a printer unit 100 are physically integrated and arranged in FIG. 8, they can be separately arranged. The scanner unit 800 is constructed by a platen glass 801 serving as an original putting plate, scanning mirrors 804, 805, and 806, a lens 807, and an image sensor 808. The printer unit 100 is mainly constructed by an image forming unit 10 (four stations a, b, c, and d are arranged in parallel and their constructions are the same), a paper feeding unit 20, an intermediate transfer unit 30, a fixing unit 40, and a control unit (not shown).

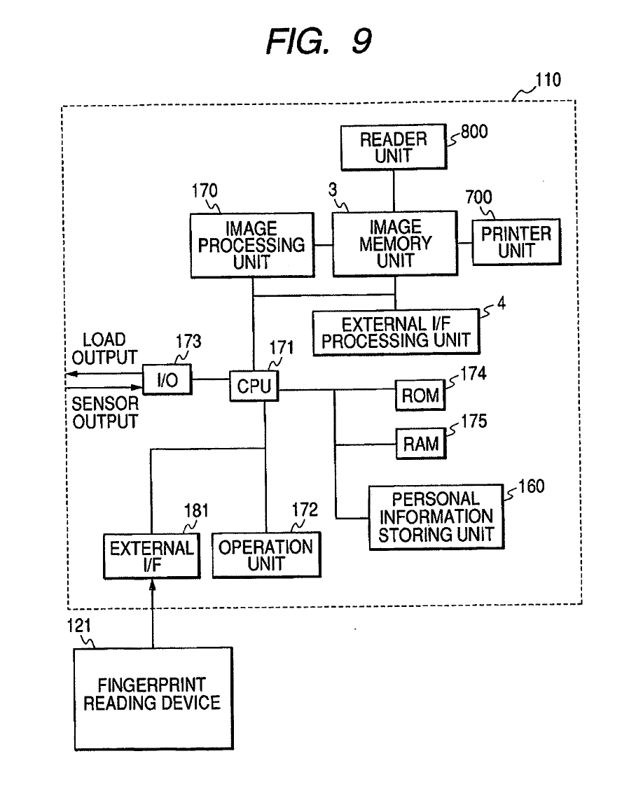

FIG. 9 is a control block diagram of the image forming apparatus 110. The image forming apparatus 110 is constructed by: a CPU 171 to make fundamental control; a ROM 174 in which a control program has been written; a work RAM 175 to execute processes; an input/output port (I/O port) 173; and the like. Their functions are connected by an address bus and a data bus. Various loads (not shown) such as motor, clutch, and the like for controlling the image forming apparatus 110 and inputs (not shown) of a sensor for detecting a position of the paper and the like are connected to the I/O port 173.

The CPU 171 makes various kinds of control on the basis of the program stored in the ROM 174. For example, the CPU 171 sequentially controls an input and an output through the I/O port 173 and executes the image forming operation. An operation unit 172 is connected to the CPU 171. The CPU 171 controls display means and key input means of the operation unit 172. The operator instructs the CPU 171 to switch an image forming operating mode and a display mode through the key input means. The CPU 171 displays a state of the image forming apparatus 110 and operating mode setting by the key input. An image processing unit 170 and an image memory unit 3 to accumulate processed images are connected to the CPU 171.

A reader unit 200, an external I/F processing unit 4, and the printer unit 100 are connected to the image memory unit 3. A predetermined image process is executed to an image of the original read by the reader unit 200 and, thereafter, the processed image data is sent to the image memory unit 3 and accumulated therein. Since the image data which is inputted from the external I/F processing unit 4 has already been image-processed, it is sent to the image memory unit 3 as it is.

The image data sent to the image memory unit 3 from the reader unit 200 and the external I/F processing unit 4 is transmitted to the printer unit 100 and an image corresponding to the image data is formed on a sheet.

<Computer Apparatus>

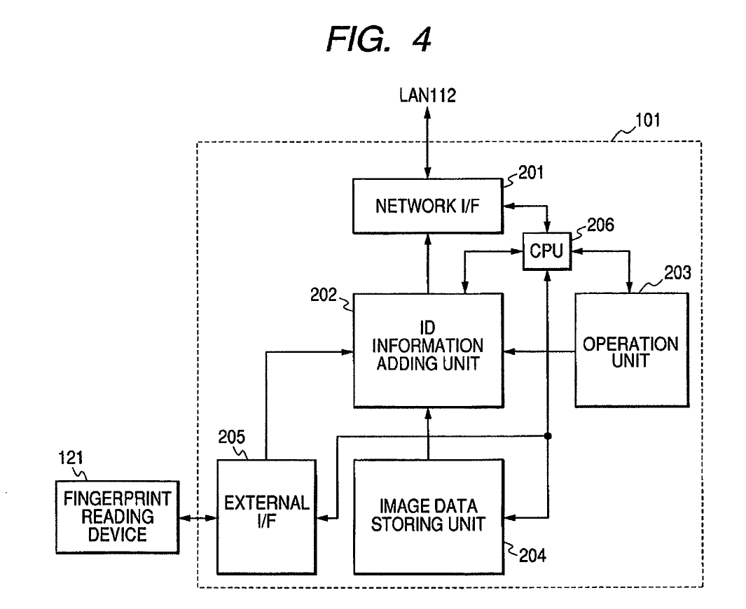

FIG. 4 is a block diagram showing a construction of the computer 101. The computer 101 is connected to the ID information input device 121 through an external I/F 205. The ID information is added to the print data by an ID information adding unit 202. An operation unit 203 is a keyboard, a touch panel, or the like. The operator can input the user ID by the operation unit 203.

<Fingerprint Reading Device>

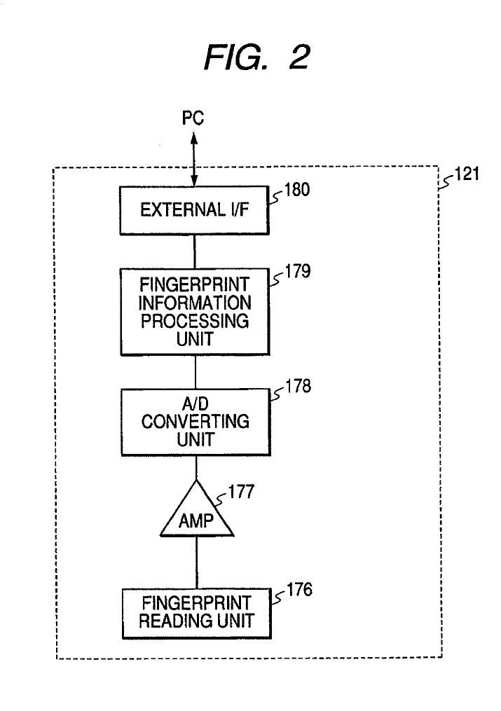

FIG. 2 is a constructional diagram of the fingerprint reading device. First, a fingerprint of the user is photographed and read by a fingerprint reading unit 176. An analog image signal corresponding to the read fingerprint is amplified by an amplifier 177. The amplified analog signal is converted into digital data by an A/D converting unit 178. A fingerprint information processing unit 179 extracts feature amount data of the fingerprint from the digital data. The extracted fingerprint feature amount data is outputted to the computer or the image forming apparatus through an external I/F 180.

Upon personal authentication, personal information data recorded in the personal computer 101 is read out at predetermined timing and compared with the feature amount data corresponding to the fingerprint of the user inputted through the A/D converting unit 178 and the fingerprint information processing unit 179. Whether or not the user is a pre-registered user can be also discriminated on the basis of a comparison result.

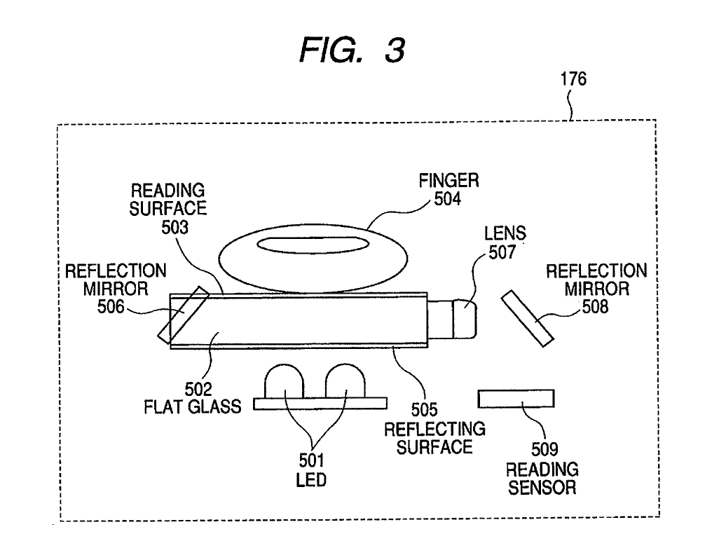

FIG. 3 is a detailed diagram of the fingerprint reading unit 176 in FIG. 2. A finger 504 is put on a reading surface 503 and its fingerprint is read. LEDs 501 irradiate light of a predetermined intensity onto the reading surface 503 of an upper surface of a flat glass 502. The finger 504 of the user is put on the reading surface 503. In the reflection light which has been irradiated onto the reading surface 503 and reflected thereby, the light on the convex portions of the fingerprint is totally reflected by a reflecting surface 505 of the bottom of the flat glass 502, while the light on the concave portions of the fingerprint is transmitted through the flat glass 502.

The reflection light of the convex portions of the fingerprint which has been totally reflected by the reflecting surface 505 is reflected by a reflection mirror 506 and converged by a lens 507. The reflection light converged by the lens 507 is further reflected again by a reflection mirror 508 and enters a reading sensor 509. The reading sensor 509 converts a photosignal (image signal) into an electric signal by using a semiconductor device (photodiode) whose accumulation capacitance changes in accordance with the input of the light.

Flow for Printing Process

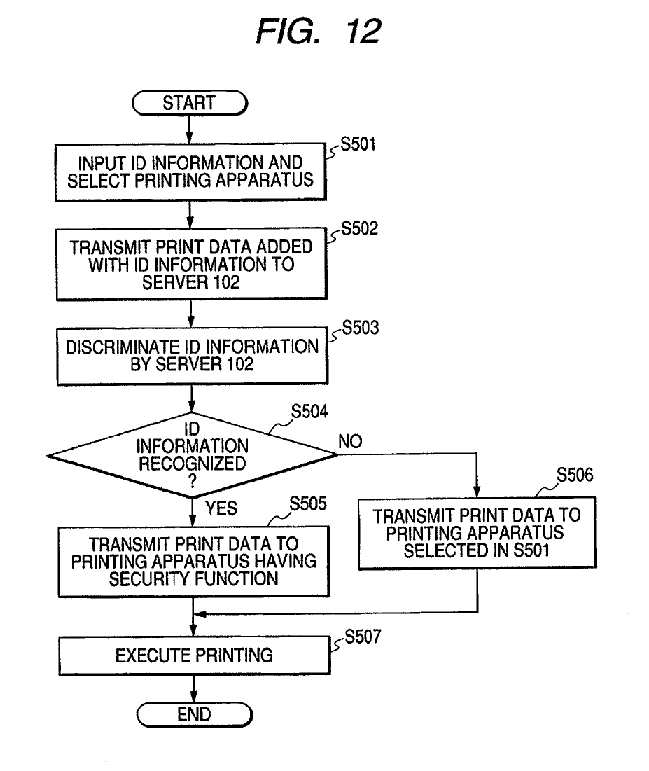

A whole flow of the printing process will now be described. FIG. 12 is a flowchart for explaining the flow for the printing process.

When the operator intends to output the print data stored in the computer 101 by a desired printing apparatus (for example, image forming apparatus 107), a process in step S501 is executed. In S501, the ID information of the user is inputted from the operation unit 203 of the computer 101 or from the fingerprint reading device 121 connected to the computer and, further, the desired printing apparatus is selected. The ID information which has preliminarily been added to the job can be also used as ID information.

In next step S502, the ID information is added to the print data and the print data is transmitted to the printer server 102.

In step S503, the ID information of the print data is discriminated by an ID information discriminating unit 302 of the printer server 102.

In step S504, the ID information discriminating unit 302 recognizes the ID information added to the print data. If it can be recognized, step S505 follows. If it cannot be recognized, step S506 follows.

In step S505, the print data is transmitted to the printing apparatus having the security function. The printing is executed in step S507.

In step S506, the print data is transmitted to the printing apparatus selected in step S501. The printing is executed in step S507. A domain address of the computer 101 of a transmitting source side and a domain address showing an address on the network of the printing apparatus of an output destination side whose printing has been instructed by the computer 101 are added to the print data (image forming command) which is transmitted in step S502, respectively.

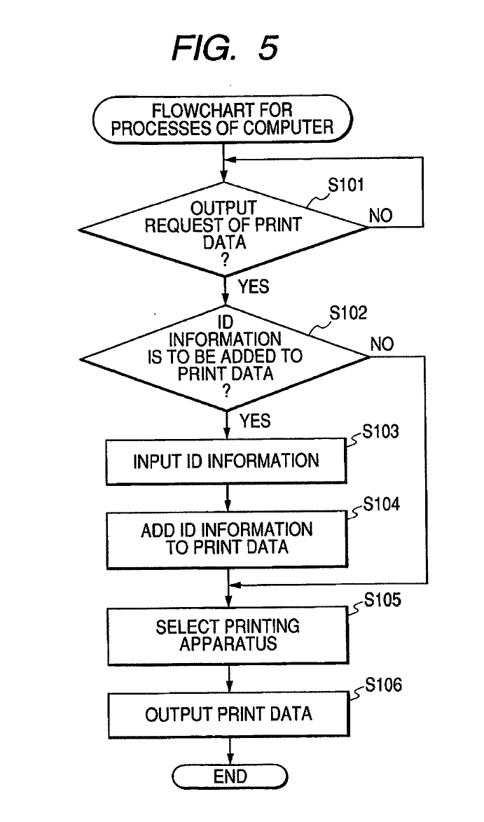

A processing procedure in the computer 101 will now be described in detail. FIG. 5 is a flowchart for explaining the processes of the computer 101. First, when there is an output request (S101) of the print data, a control unit (CPU) 206 of the computer 101 inquires of the user whether or not the ID information (authentication information) is to be added to the print data (S102). At this time, if the user does not request the addition of the ID information to the print data, step S105 follows. The printing apparatus which outputs the print data is selected and the print data is outputted to the printer server 102. If the user requests the addition of the ID information, the ID information such as a password or the like or the ID information of the fingerprint read by the fingerprint reading device 121 is inputted from the operation unit 203 of the computer 101 (S103). As for the ID information of the fingerprint, the fingerprint information read by the fingerprint reading device 121 is inputted to the computer 101 through the external I/F 205. The print data to be outputted has been stored in an image data storing unit 204. The print data is inputted to the ID information adding unit 202 from the image data storing unit 204. The ID information is added to the print data by the ID information adding unit 202 (S104). Subsequently, the printing apparatus is selected (S105). The print data is outputted to the printer server 102 through a network I/F 201 (S106).

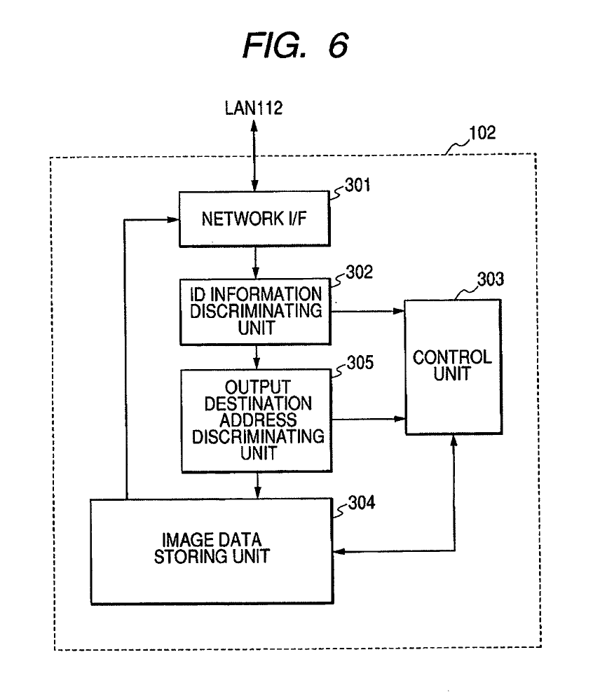

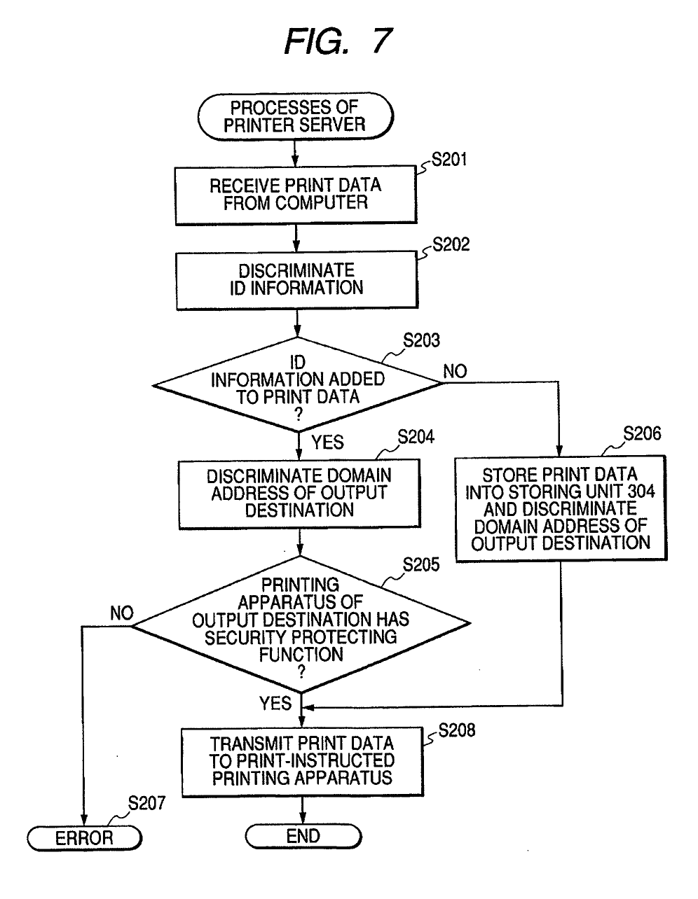

A processing procedure in the printer server 102 will now be described in detail. FIG. 6 is a diagram showing a construction of the printer server 102. FIG. 7 is a flowchart for explaining processes of the printer server 102.

First, the printer server 102 receives the print data from the computer through a network I/F 301 (S201) and inputs the print data. The inputted print data is transmitted to the ID information discriminating unit 302. The ID information (authentication information) is discriminated (S202). Whether or not the ID information has been added to the print data is discriminated by the ID information discriminating unit 302 (S203). If no ID information is added to the received print data, a control unit 303 is notified that the ID information is not added to the received print data. The print data is temporarily stored in an image data storing unit 304. The domain address of the print-designated output destination which has been added to the print data is discriminated by an output destination address discriminating unit 305 (S206). The print data is transferred to the printing apparatus of the discriminated domain address (S208).

If it is determined in S203 that the ID information has been added to the received print data, the control unit 303 is notified that the ID information has been added. In step S204, the domain address added to the print data is discriminated by the output destination address discriminating unit 305.

In S205, whether or not the printing apparatus of the output destination designated by the domain address has a security protecting function is discriminated. If the printing apparatus has the security protecting function such as authenticating means or the like of the ID information, S208 follows. If the printing apparatus does not have the security protecting function, S207 follows and the computer of the user is notified of an error indication. At this time, it is also possible to notify the computer of the printing apparatus having the security protecting function.

On the basis of discrimination results of the ID information discriminating unit 302 and the output destination address discriminating unit 305, the control unit 303 controls so as to decide the output destination to which the print data should be transferred. If it is determined by the ID information discriminating unit 302 that the ID information has been added to the print data and if it is determined by the output destination address discriminating unit 305 that the printing apparatus of the output destination has the security protecting function such as BOX function, authenticating means, or the like, the print data is transmitted to the printing apparatus designated by the computer. If it is determined by the ID information discriminating unit 302 that the ID information has been added to the print data and if it is determined by the output destination address discriminating unit 305 that the printing apparatus of the output destination does not have the security protecting function, the print data is not transmitted to the designated printing apparatus but an error notification is transmitted to the computer. At this time, it is also possible to notify the computer of the printing apparatus having the security protecting function.

In S208, after the print data is temporarily stored in the image data storing unit 304, the print data is transferred to the printing apparatus of the output destination designated by the domain address discriminated by the output destination address discriminating unit 305.

In S207, the print data is not transmitted to the image output apparatus but the processing routine is finished as an error and the computer of the user is notified of an error indication. In this instance, it is also possible to notify the computer of the printing apparatus having the security protecting function.

It is also possible to construct in such a manner that the ID information discriminating unit 302 and the output destination address discriminating unit 305 are assembled in the computer 101 and, if it is determined that the ID information has been added to the print data, the printing apparatus without the security protecting function cannot be selected. Specifically speaking, when the printing apparatus is selected in S501 in FIG. 12, the printing apparatus without the security protecting function is not displayed to the operation unit 203, thereby disabling such a printing apparatus to be selected.

The ID authentication and image outputting method in the printing apparatus will now be described.

The print data received from the printer server 102 is fetched into the image forming apparatus 110 through the external I/F processing unit 4. The ID information is discriminated by the image processing unit 170. If there is no ID information, the print data is outputted as it is. If the ID information exists, the user is promoted to execute the authenticating operation of the ID. If the image processing unit 170 determines that the ID information inputted by the user coincides with the ID information added to the data, an image is formed. If they do not coincide, no image is formed. For example, if the ID information is added by the fingerprint reading device 121 of the computer 101, the ID information is fetched by the fingerprint reading device 121 of the image forming apparatus 110. Only when the discrimination result indicates the coincidence of those ID information, the image is outputted.

As described above, according to the embodiment 1, since the transmission of the print data is controlled in accordance with the discrimination result about whether or not the printing apparatus of the output destination has the security protecting function, it is possible to prevent such a situation that the print data having the ID information is erroneously transmitted to the printing apparatus without the security protecting function and printed.

### Second Embodiment

In the first embodiment, the ID information is discriminated in the printer server 102 and when the print data added with the ID information is received, the image can be outputted to the image forming apparatuses 107 and 110 having the security protecting function. That is, in the computer 101, even if the ID information of the high security level is added, the print data is transmitted to all of the printing apparatuses having the security protecting function.

In the first embodiment, if the ID information has been added, the print data is transmitted to the printing apparatuses having the security protecting function irrespective of the security levels of the printing apparatuses. However, in the second embodiment, the print data is transferred to the printing apparatuses having the security levels higher than the security level of the ID information inputted by the user. Explanation will be made in detail hereinbelow.

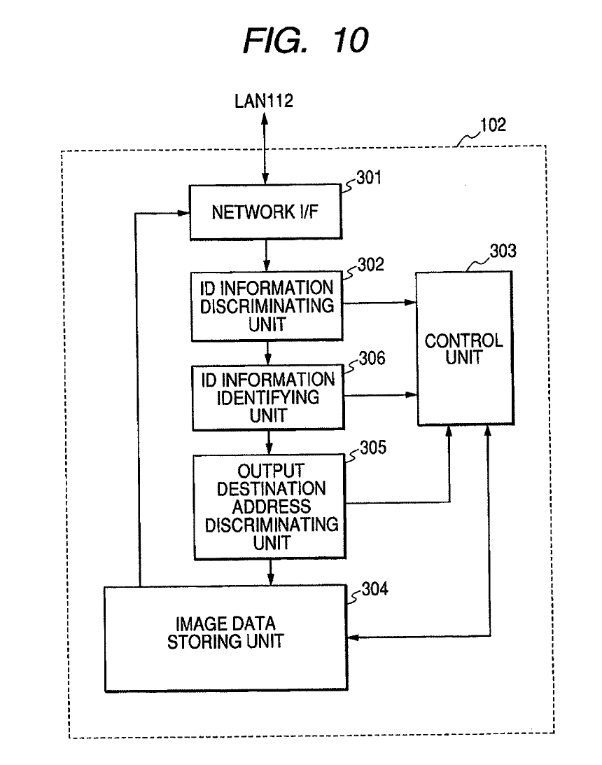

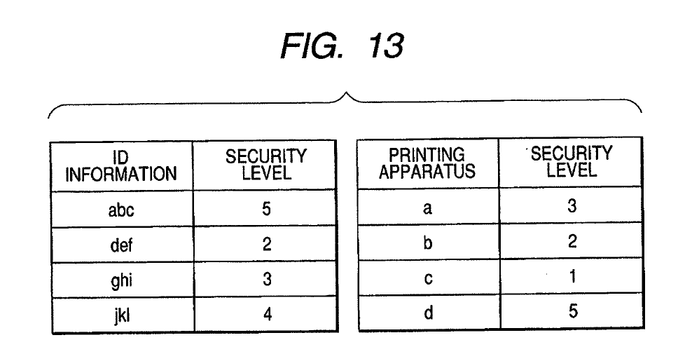

The whole system configuration is similar to that of the first embodiment and processes in the computer and the image output apparatus are also similar to those of the first embodiment except that the processes in the printer server differ. FIG. 10 is a diagram showing a construction of the server 102 in the second embodiment. FIG. 10 differs from FIG. 6 with respect to a point that an ID information identifying unit 306 is added after the ID information discriminating unit 302. A table of pairs of the ID information and the security levels as shown in FIG. 13 has been stored in the ID information identifying unit 306. A table of pairs of the printing apparatuses and the security levels has been stored in the output destination address discriminating unit 305. The output destination address discriminating unit 305 and the ID information identifying unit 306 are also used as storing units to store the tables. The printing apparatus corresponding to the ID information added to the print data is determined in the control unit 303 from the tables. The print data can be also transferred only to the printing apparatuses having the security levels higher than the security level corresponding to the ID information added to the print data. On the other hand, the print data cannot be transferred to the printing apparatuses having the security levels lower than the security level corresponding to the ID information.

For example, it is now assumed that a printing apparatus (a) has been selected by the computer 101 and the print data added with ID information “def” has been transmitted to the printer server 102. Since the ID information “def” has the security level “2” and the printing apparatus (a) has the security level “3”, the security level of the printing apparatus is higher than that of the ID information. Therefore, the print data can be transmitted to the printing apparatus (a) selected by the computer 101. It is also assumed that a printing apparatus (c) has been selected by the computer 101 and the print data added with ID information “def” has been transmitted to the printer server 102. Since the security level of the ID information “def” is equal to “2” and the security level of the printing apparatus (c) is equal to “1”, the security level of the printing apparatus is lower than that of the ID information. Therefore, the print data is not transmitted to the printing apparatus (c) selected by the computer 101 but the error notification is transmitted to the computer 101 of the user.

The security level can be also discriminated in the computer by using such a principle that an amount of ID information of encryption data by the key input is small and an amount of ID information formed from the feature amount data of the fingerprint is large. For example, since the amount of ID information of encryption data by the key input is small, the security level is set to “1”. Since the amount of ID information formed from the feature amount data of the fingerprint is large, the security level is set to “3”.

It is also possible to construct in such a manner that the table showing the security level corresponding to the ID information and the table showing the security level corresponding to the printing apparatus shown in FIG. 13 are stored in the computer 101 and the printing apparatus whose security level is lower than that of the ID information cannot be selected. Specifically speaking, when the printing apparatus is selected in S501 in FIG. 12, the printing apparatuses whose security levels are lower than that of the ID information are not displayed on the operation unit 203 on the basis of the tables of FIG. 13, thereby disabling such printing apparatuses to be selected.

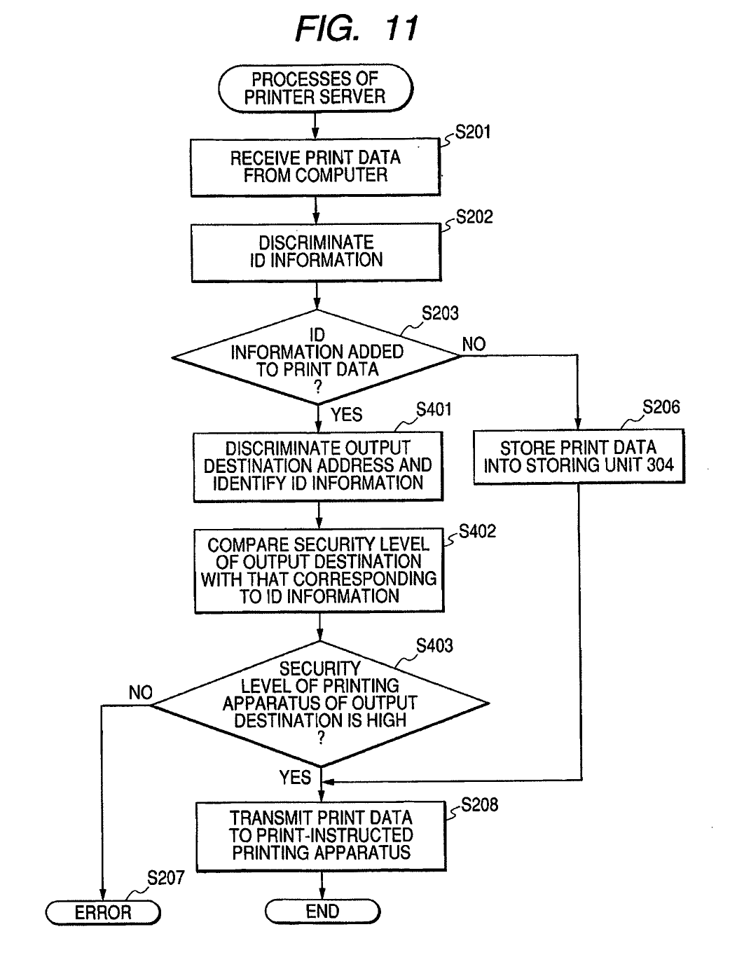

FIG. 11 is a flowchart for explaining the processes in the printer server 102.

Since processes of steps S201 to S203 and S206 to S208 in FIG. 11 are similar to those in the first embodiment, their description is omitted and only processes of steps S401 to S403 will be described hereinbelow.

In S401, the control unit 303 is notified that the ID information has been added. The domain address added to the print data is discriminated by the output destination address discriminating unit 305, the ID information added to the print data is identified by the ID information identifying unit 306, and the control unit 303 is notified of the output destination and the security level of the ID information.

In S402, the control unit 303 compares the security level of the output destination with the security level corresponding to the ID information.

In S403, whether or not the security level of the printing apparatus of the output destination is higher than the security level added to the ID information. If it is higher than the added security level, S208 follows. If it is lower, S207 follows and the computer 101 is notified of the error indication. At this time, it is also possible to notify the computer of the printing apparatuses whose security levels are higher than the security level added to the ID information.

As described above, according to the second embodiment, the security level of the printing apparatus of the output destination of the print data is compared with the security level of the ID information added to the print data and the transfer of the print data to the printing apparatus is controlled in accordance with the comparison result. Therefore, the image forming system of the high security level can be constructed.

### Other Embodiments

The object of the invention is also accomplished by a method whereby a storage medium in which program codes of software to realize the functions of the embodiments mentioned above have been stored is supplied to the system or apparatus and a computer (or a CPU or an MPU) of the system or apparatus reads out the program codes stored in the storage medium and executes them.

In this case, the program codes themselves read out of the storage medium realize the functions of the embodiments mentioned above and the program codes or the storage medium in which the program codes have been stored constructs the invention.

As a storage medium to supply the program codes, for example, a floppy disk, a hard disk, an optical disk, a magnetooptic disk, a CD-ROM, a CD-R, a DVD-ROM, a DVD-R, a magnetic tape, a non-volatile memory card, a ROM, or the like can be used. Further, any kind of recording media such as storing device which a file server on the network has, storing device which an FTP server on the Internet has, and the like can be used.

The invention incorporates not only the case where the computer executes the read-out program codes, so that the functions of the embodiments mentioned above are realized but also the case where an OS (Operating System) or the like which is operating on the computer executes a part or all of actual processes on the basis of instructions of the program codes and the functions of the embodiments mentioned above are realized by those processes.

The invention is not limited to the foregoing embodiments but various modifications (including organic combinations of the embodiments) are possible on the basis of the spirit of the invention and are not excluded from the scope of the invention.

As many apparently widely different embodiments of the present invention can be made without departing from the spirit and scope thereof, it is to be understood that the invention is not limited to the specific embodiments thereof except as defined in the appended claims.

This application claims priority from Japanese Patent Application No. 2005-009072 filed Jan. 17, 2005, which is hereby incorporated by reference herein.

What is claimed is:

1. An image forming system in which an image processing apparatus and an information processing apparatus are connected, wherein
said image processing apparatus transmits print data added with authentication information to said information processing apparatus, and
said information processing apparatus receives the print data, discriminates whether or not the authentication information has been added to the print data, and controls an output destination of the print data on the basis of a result of the discrimination.

2. A system according to claim 1, wherein the authentication information is biometrics information.

3. A system according to claim 1, wherein the output destination of the print data is controlled on the basis of the authentication information and a security level of the output destination in addition to the discrimination result.

4. A system according to claim 3, wherein a table in which the authentication information and the security level are made to correspond to each other has been stored in said information processing apparatus.

5. A system according to claim 3, wherein a table in which the output destination and the security level are made to correspond to each other has been stored in said information processing apparatus.

6. An information processing apparatus comprising:
an input unit adapted to input print data;
a discriminating unit adapted to discriminate whether or not authentication information has been added to the print data inputted by said input unit; and
a control unit adapted to control an output destination of the print data on the basis of a result of the discrimination by said discriminating unit.

7. An apparatus according to claim 6, wherein the authentication information is biometrics information.

8. An apparatus according to claim 6, wherein in said control unit, the output destination of the print data is controlled on the basis of the authentication information and a security level of the output destination in addition to the discrimination result.

9. An apparatus according to claim 6, wherein in said control unit, a security level of the authentication information and a security level of the output destination are compared and when the security level of the output destination is higher than the security level of the authentication information as a result of the comparison, the print data is transferred to a printing apparatus.

10. An apparatus according to claim 6, wherein in said control unit, a security level of the authentication information and a security level of the output destination are compared and when the security level of the output destination is lower than the security level of the authentication information as a result of the comparison, an error is displayed.

11. An apparatus according to claim 8, further comprising a storing unit adapted to store a table in which the authentication information and the security level are made to correspond to each other.

12. An apparatus according to claim 8, further comprising a storing unit adapted to store a table in which the output destination and the security level are made to correspond to each other.

13. An information processing method comprising:
an input step of inputting print data;
a discriminating step of discriminating whether or not authentication information has been added to the print data inputted in said input step; and
a control step of controlling an output destination of the print data on the basis of a result of the discrimination by said discriminating step.

14. A program embedded in a computer-readable storage medium, wherein said program allows a computer to execute:
a discriminating code for discriminating whether or not authentication information has been added to print data; and
a control code for controlling an output destination of the print data on the basis of a result of the discrimination by said discriminating code.
